(19) United States
(12) Patent Application Publication
(10) Pub. No.: US 2014/0281594 A1
(43) Pub. Date: Sep. 18, 2014

(54) APPLICATION PROCESSOR AND DRIVING METHOD

(71) Applicant: SAMSUNG ELECTRONICS CO., LTD., Suwon-Si (KR)

(72) Inventors: HUI-KAP YANG, HWASEONG-SI (KR); SOO-HWAN KIM, YONGIN-SI (KR); MYUNG-KYOON YIM, SEOUL (KR)

(73) Assignee: SAMSUNG ELECTRONICS CO., LTD., Suwon-Si (KR)

(21) Appl. No.: 14/188,755

(22) Filed: Feb. 25, 2014

(30) Foreign Application Priority Data
Mar. 12, 2013 (KR) 10-2013-0026389

(51) Int. Cl. G06F 1/26

(52) U.S. Cl. CPC G06F 1/26
USPC 713/300

(57) ABSTRACT

In a system including a power management integrated circuit (PMIC) and a memory device, an application processor obtains control information for a memory device, the control information defining in part at least a first power supply voltage and operating clock frequency for the memory device. A memory control unit (MCU) communicates a workload indication related to queued operation commands for the memory device to a digital voltage and frequency scaling (DVFS) controller, and the DVFS controller provides a power supply voltage command to the PMIC in response to the MCU workload indication and the control information.

### CROSS-REFERENCE TO RELATED APPLICATION

This application claims priority under 35 U.S.C. §119 to Korean Patent Application No. 10-2013-0026389 filed Mar. 12, 2013, the disclosure of which is hereby incorporated by reference.

### BACKGROUND

The inventive concept relates to application processors and driving methods for application processors. More particularly, the inventive concept relates to application processors and driving methods that are capable of controlling the operation of a memory device based on the operating speed of the memory device and corresponding voltage information.

Contemporary mobile communication systems are highly complex and generally require a number of processors to control a range of logic, computational and communication functions. As will be appreciated by those skilled in the art, processors usually operate in accordance with one or more clock signal and power supply voltages.

Processors are relatively power hungry components and power consumption is an important design consideration, particularly in mobile communication systems. Accordingly, considerable efforts have been expended in the design of power-efficient processors. Yet, processor performance (e.g., the speed with which a processor is capable of performing computations and data processing) is facilitated by the application of relatively high power supply voltage(s) and fast (high frequency) clock signal(s).

Recognizing the inherent tradeoff between performance and power consumption certain processors have been developed that provide different performance levels based on the requirements of an application program being run by the processor. Such “variable performance processors” markedly reduce power consumption by reducing the frequency of an applied clock signal and/or reducing the level of an applied operating power supply voltage. However, reductions in processor performance may not negatively impact a user's experience with a constituent device incorporating the processor. Further, operating clock frequencies and/or operating power supply voltages may not be reduced to the point where circuit or system malfunctions occur. Still further, many contemporary applications must be executed within a defined minimum period that may not be reduced by a reduction in processor performance. Finally, it is often possible to more efficiently regulate power consumption by having a processor reduce (or slow) the execution of certain tasks over a given period of time, rather than operating at a higher performance level and then entering an idle mode.

### SUMMARY

Embodiments of the inventive concept provide an application processor capable of applying a desired voltage to a memory device according to the operating speed of the memory device. Other embodiments of the inventive concept provide a method of driving the application processor.

In accordance with an aspect of the inventive concept, an application processor includes a memory controller configured to control a memory device; and a dynamic voltage and frequency scaling (DVFS) controller configured to receive information regarding a workload of the memory controller, and transmit a command to a power management integrated circuit (PMIC), based on a table storing voltage information corresponding to an operating clock frequency of the memory device. A first power supply voltage controlled according to the command is applied to the memory device from the PMIC.

In one embodiment, the memory controller and the memory device may be included in the same clock domain.

In one embodiment, the information regarding the workload of the memory controller may include information regarding an amount of current works of the memory controller.

In one embodiment, the PMIC may apply a second power supply voltage to the memory controller, and control the second power supply voltage under control of the DVFS controller.

In one embodiment, the DVFS controller may supply the command to the PMIC to control an operating clock frequency of the memory controller, and apply the second power supply voltage to the memory controller according to the operating clock frequency.

In one embodiment, the table stores at least one of a manufacturing company, product name, and process revision identification (ID) of the memory device.

In one embodiment, the table may further store information regarding a minimum operating voltage corresponding to the process revision ID

In one embodiment, the application processor may further include a non-volatile memory device configured to store the table, and the DVFS controller may read the table from the non-volatile memory device.

In one embodiment, the memory device may store the table, and transmit the table to the DVFS controller via the memory controller.

In one embodiment, the memory device may include a dynamic random access memory (DRAM), and the memory controller comprises a DRAM controller.

In accordance with another aspect of the inventive concept, a method of driving an application processor, which includes a memory controller configured to control a memory device, includes reading a table storing voltage information corresponding to an operating clock frequency of the memory device, transmitting information regarding a workload of the memory controller to the DVFS controller, and transmitting a command corresponding to the workload to the PMIC, based on the table.

In one embodiment, the method may further include controlling a voltage to be applied to the memory device, in response to the command.

In one embodiment, the method may further include checking the memory device through a mode register read (MRR) operation performed by the memory controller.

In one embodiment, the checking of the memory device may include checking a manufacturing company, product name, and process revision identification (ID) of the memory device.

In one embodiment, the reading of the table may include reading the table from the memory device through the memory controller.

### BRIEF DESCRIPTION OF THE DRAWINGS

FIG. 1 is a general block diagram illustrating a computer system in accordance with an embodiment of the inventive concept;

FIG. 2 is a block diagram further illustrating in one embodiment the application processor (AP) of FIG. 1;

FIG. 3 is a table listing an exemplary set of commands that may be used to control the application processor of FIG. 2;

FIG. 4 is a block diagram illustrating an exemplary voltage target table (VTT) that may be used in characterize that application processor of FIG. 2;

FIG. 5 is a flowchart summarizing one possible method of driving the application processor of FIG. 2 in accordance with an embodiment of the inventive concept;

FIG. 6 is a block diagram illustrating a computer system in accordance with another embodiment of the inventive concept;

FIG. 7 is a flowchart summarizing one possible method of driving the computer system of FIG. 6 in accordance with embodiment of the inventive concept;

FIG. 8, FIG. 9 and FIG. 10 are respective block diagrams illustrating computer systems including the application processor of FIG. 2 in accordance with certain embodiments of the inventive concept.

### DETAILED DESCRIPTION

Particular structural and functional descriptions related to certain embodiments of the inventive concept will now be set forth in some additional detail. However, the inventive concept may be variously embodied should not be construed as being limited to only the illustrated embodiments. Throughout the written description and drawings like reference numbers and labels will be used to denote like or similar elements, steps and/or features.

It will be understood that, although the terms ‘first’, ‘second’, ‘third’, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present inventive concept. Similarly, a second element, component, region, layer, or section discussed below could be termed a first element, component, region, layer, or section

It will be understood that when an element or layer is referred to as being “connected to,” or “coupled to” another element or layer, it can be directly connected or coupled to the other element or layer, or intervening elements or layers may be present. In contrast, when an element is referred to as being “directly connected to,” or “directly coupled to” another element or layer, there are no intervening elements or layers present. Similarly, other expressions describing the relations among constitutional elements, e.g., “between,’ and “directly between,”, or “adjacent to,” and “directly adjacent to,” should be construed.

The terminology used herein is for the purpose of describing particular embodiments only and is not intended to be limiting of the inventive concept. As used herein, the singular forms “a,” “an,” and “the” are intended to include the plural forms as well, unless the context clearly indicates otherwise. It will be further understood that the terms “comprise” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 is a general block diagram illustrating a computer system 100 in accordance with an embodiment of the inventive concept. The computer system 100 comprises an application processor 110, a memory device 120, and a power management integrated circuit (PMIC) 130. The PMIC is configured to efficiently manage the provision of certain power supply voltages to both the application processor 110 and the memory device 120.

As will be appreciated by those skilled in the art, the application processor 110 is capable of accessing (e.g., reading, writing and/or erasing) data from the memory device 120. In certain embodiments, the application processor 110 may include a designated memory controller (not shown) to control the operation of the memory device 120. The application processor 110 will be described in some additional detail with reference to FIG. 2 hereafter.

Consistent with the foregoing, the application processor 110 may be applied to smart phones, tablet personal computers (PCs), digital cameras, smart televisions (TVs), etc.

In certain embodiments, the memory device 120 may be embodied as a volatile memory such, such as a dynamic random access memory (DRAM).

The PMIC 130 may be embodied by one or more integrated circuits configured to transform, manage, and/or distribute power supply voltage(s) to circuitry in the application processor 110 and memory device 120. A power supply voltage must be stably supplied to properly power a host device given various system and environmental conditions. In addition, the PMIC 130 may function as an AC-to-DC voltage converter, or a DC-to-DC voltage converter. The PMIC 130 may also control and/or perform such functions as battery charging, power supply voltage selection, power supply voltage level control, etc.

Thus, as the workload of the application processor 110 increases, the PMIC 130 may increase a power supply voltage applied to the application processor 110. Similarly, when the workload of the application processor 110 decreases, the PMIC 130 may decrease the power supply voltage applied to the application processor 110.

In general operation, the PMIC 130 may seek to apply a constant power supply voltage regardless of the operating speed of the memory device 120. However, in the context of certain embodiments of the inventive concept, the application processor 110 may control the PMIC 130 such that the power supply voltage applied to the memory device 120 varies according to a current operating speed of the memory device 120. Thus functionality will be described in some additional detail with reference to FIGS. 2 and 3 hereafter.

FIG. 2 is a block diagram further illustrating the application processor 110 of FIG. 1.

Referring to FIG. 2, the application processor 110 comprises a central processing unit (CPU) 111, a peripheral (Peri) block 112, a memory control unit (MCU) 113, a dynamic voltage and frequency scaling (DVFS) controller 115, and a non-volatile memory device 116.

The application processor 110 may also include a system bus 117 used to communicate data and information between the CPU 111, peripheral block 112, and MCU 113

The CPU 111 may be used to control the operation of the peripheral block 112. The CPU 111 may also be used to control access to data stored in the memory device 120 via the MCU 113. In one particular embodiment of the inventive concept, the CPU 111 is embodied as the ARM™ processor.

The peripheral block 112 is a subsidiary block to the CPU 111, but may in certain embodiments be subsumed within the CPU 111. Although not shown in specific detail by FIG. 2, those skilled in the art will understand that the peripheral block 112 may include one or more input/output (IO) interface block(s), a universal serial bus (USB) block, a USB slave block, etc.

The MCU 113 may be used in conjunction with the CPU 111 to control access to the memory device 120. The MCU 113 may include a memory controller input/output (MCIO) block 114 configured to interface with the memory device 120. The memory device 120 may include a memory input/output (MIO) block 121 configured to interface with the MCU 113. The MCIO 114 may be connected to the MIO 121. Where the memory device 120 is assumed to be a DRAM, the MCU 113 may be embodied as a DRAM controller.

The DVFS controller 115 may be used to control one or more power supply voltage(s) applied to the CPU 111, the peripheral block 112, and the MCU 113 by the PMIC 130 in response to respective workloads. Hereafter, the definition, control, and application of a “power supply voltage” will be described recognizing that embodiments of the inventive concept may provide more than one power supply voltage in similar manner. That is, the DVFA controller 115 may be used to define one or more power supply commands (cmd) applied to the PMIC 130.

For example, when a large number of operation commands are stored in a work queue of the MCU 113, the MCU 113 may communicate a “MCU workload indication” (MS) to the DVFS controller 115. In response of this workload information, the DVFS controller 115 will define and apply an appropriate power supply command (cmd) to the PMIC 130. Such power supply commands may increase or decrease the level of the power supply voltage provided by the PMIC 130.

In this regard, the non-volatile memory device 116 may be used to store the control information used to make a determination regarding appropriate power supply commands. Such control information may take the form of a voltage target table (VTT) in certain embodiments of the inventive concept. For example, one type of VTT may store control information defining an operating clock frequency for the memory device 120. An exemplary VTT will be described in some additional detail with reference to FIG. 3 hereafter.

The MCU 113 and the memory device 120 may have the same frequency domain (i.e., may use the same clock frequency). In other words, the operating clock frequency for the DRAM may be determined in relation to the operating clock frequency of the MCU 113. Thus, when the pending workload indicated by queued operation commands directed to the MCU 113 is high, a corresponding number of operations to be executed by the memory device 120 may be also assumed to be relatively high.

FIG. 3 is a table listing an exemplary set of power supply commands that may be used in accordance with the application processor 110 of FIG. 2.

Referring to FIGS. 2 and 3, the CPU 111 may communicate a “CPU workload indication” (CS) to the DVFS controller 115. In turn, the DVFS controller 115 may communicate an appropriate power supply command (cmd) in response to the CPU workload indication (CS) to the PMIC 130. The PMIC 130 may then provide a CPU power supply voltage (Vc) to the CPU 111 in response to a power supply command (cmd) received from the DVFS 115.

Similarly, the peripheral block 112 may communicate a “peripheral workload indication (PS) to the DVFS controller 115. In turn, the DVFS controller 115 may communicate an appropriate power supply command (cmd) in response to the peripheral workload indication (PS) to the PMIC 130. The PMIC 130 may then provide a peripheral block power supply voltage (Vp) to the peripheral block 112.

And in response to the MCU workload indication (MS) communicated to the DVFS controller 115, the DVFS controller 115 may communicate an appropriate power supply command (cmd) to the PMIC 130. The PMIC 130 may then provide a MCU power supply voltage (Vm) to the MCU 113 and a MCU I/O block power supply voltage (Vio) to the MCIO 114 and the MIO 121. In this regard, the PMIC 130 will in certain embodiments of the inventive concept also apply a memory device power supply voltage (Vd) to the memory device 120 based on one or more power supply voltage command(s) in view of the various workloads.

For example, the DVFS controller 115 may communicate one of a number of possible CPU power supply voltage commands (e.g., CPU_A, CPU_B, CPU_C, and CPU_D) to the PMIC 130 based on a current CPU workload indication (CS), and the PMIC 130 may apply an appropriate CPU power supply voltage (Vc) corresponding to the command. That is, when the PMIC 130 receives the command CPU_A, the PMIC 130 may set the CPU power supply voltage Vc to (e.g.,) DD1. Using the same control function, the DVFS controller 115 may also set a control signal (e.g., CLK1) corresponding to the current CPU workload indication (CS).

Similarly, the DVFS controller 115 may communicate one of a number of possible peripheral power supply voltage commands (e.g., Peri_A or Peri_B) to the PMIC 130 based on a current peripheral workload indication (PS), and the PMIC 130 may apply an appropriate peripheral power supply voltage (Vp) corresponding to the command. That is, when the PMIC 130 receives the command Peri_A, the PMIC 130 may set the level of the peripheral power supply voltage (Vp) applied to the peripheral block 112 to (e.g.,) VDD1. Using the same control function, the DVFS controller 115 may also set a clock signal (e.g., CLK1) corresponding to the current peripheral workload indication (PS).

And similarly, the DVFS controller 115 may communicate one of a number of possible MCU power supply commands (e.g., MCU_A, MCU_B, and MCU_C) to the PMIC 130 based on a current MCU workload indication (MS), and the PMIC 130 may apply an appropriate MCU power supply voltage (Vm) corresponding to the command. That is, when the PMIC 130 receives the command MCU_A, the PMIC 130 may set the MCU power supply voltage (Vm) applied to the MCU 113 to (e.g.,) VDD1. Using the same control function, the DVFS controller 115 may also set a clock signal (e.g., CLK1) corresponding to the current MCU workload indication (MS).

FIG. 4 is a block diagram illustrating one possible example of control information in the form of a voltage target table (VTT) for the application processor 110 of FIG. 2.

Referring to FIGS. 2 and 4, the non-volatile memory device 116 may be used to store the VTT related to the memory device 120. The DVFS controller 115 may then communicate one or more power supply commands to the PMIC 130 based on the VTT.

In the illustrated example of FIG. 4, the VTT store control information indicating the manufacturing company for the memory device, the product name or identification of the memory device, and a process revision identification (ID) for the memory device 120. The process revision ID may include process information regarding the memory device 120. The VTT may further include control information regarding a voltage (e.g., a minimum power supply voltage) defined in accordance with the process revision ID.

In certain embodiments of the inventive concept, the VTT may be used to further store control information defining certain clock frequencies (and/or power supply voltages) that correspond to the various workload indications for each one of the CPU 111, peripheral block 112, and MCU 113.

FIG. 5 is a flowchart summarizing one possible method of driving the application processor 110 of the computer system 100 described above with reference to FIGS. 1 and 2 in accordance with an embodiment of the inventive concept.

Referring collectively to the foregoing figures, the driving method of FIG. 5 begins when the MCU 113 determines the control information (i.e., checks on the type) for the memory device 120 using a conventionally understood mode register read (MRR) operation (S11). That is, the MCU 113 is able to obtain control information (e.g., the manufacturing company, product name, and process revision identification) for the of the memory device 120 using a MRR operation.

The DVFS controller 115 may also obtain additional control information (e.g., VTT) stored in the non-volatile memory device 116 (S12)

The MCU 113 then communicates a current MCU workload indication (MS) to the DVFS controller 115 (S13), and the DVFS controller 115 communicates an appropriate power supply command in response to the current MCU workload indication (MS) based on the control information contained in the VTT (S14).

The PMIC 130 than provides an appropriately defined power supply voltage to the memory device 120 in response to the power supply voltage command.

FIG. 6 is a block diagram of a computer system 200 in accordance with another embodiment of the inventive concept.

Referring to FIG. 6, the computer system 200 comprises an application processor 210, a memory device 220, and a PMIC 230 as analogously described in relation to the computer system 100 comprising application processor 110, memory device 120 and PMIC 230, except however, that a nonvolatile memory device is not internally included within the application processor 220. With this type of application processor 210, it is necessary to obtain all control information (such as the voltage target table VTT described above) directly from one or more control registers of the memory device 120.

FIG. 7 is a flowchart summarizing another driving method for the computer system 200 of FIG. 6 in accordance with an embodiment of the inventive concept.

Referring to FIGS. 6 and 7 and comparing the driving method of FIG. 5, the MCU 213 again checks the type of the memory device 220 using a MRR operation (S21). That is, the MCU 213 may obtain the manufacturing company, product name, and process revision ID for the memory device 200 using a MRR operation.

The DVFS controller 215 may obtain additional control information stored by the memory device 120 via the MCU 213 (S22).

The MCU 213 may communicate current MCU workload information (MS) to the DVFS controller 215 (S23), and the DVFS controller 215 may communicate a corresponding power supply command to the PMIC 230 (S24).

Then, the PMIC 230 may provide an appropriately defined power supply voltage to the memory device 220 in response to the power supply command (S25).

FIG. 8 is a block diagram of a computer system 310 including the application processor 110 of FIG. 2 in accordance with an embodiment of the inventive concept.

Referring to FIG. 8, the computer system 310 includes a memory device 311, a memory controller 312 configured to control the memory device 311, a radio transceiver 313, an antenna 314, an application processor 315, an input device 316, and a display unit 317.

The radio transceiver 313 may transmit or receive a radio signal via the antenna 314. For example, the radio transceiver 313 may transform the radio signal received via the antenna 314 to be processed by the application processor 315.

Thus, the application processor 315 may process a signal output from the radio transceiver 313, and transmit the processed signal to the display unit 317. Also, the radio transceiver 313 may transform a signal output from the application processor 315 into a radio signal, and output the radio signal to an external device (not shown) via the antenna 314.

The input device 316 is a device via which a control signal for controlling an operation of the application processor 315 or data that is to be processed by the application processor 315 is input, and may be embodied as a pointing device such as a touch pad and a computer mouse, a keypad, or a keyboard.

In one embodiment, the memory controller 312 configured to control an operation of the memory device 311 may be embodied as a part of the application processor 315, or may be embodied as a chip installed separately from the application processor 315.

In one embodiment, the application processor 315 may be embodied as the application processor 110 illustrated in FIG. 2.

FIG. 9 is a block diagram of a computer system 320 including the application processor 110 of FIG. 2 in accordance with another embodiment of the inventive concept.

Referring to FIG. 9, the computer system 320 may be embodied as a PC, a network server, a tablet PC, a net-book, an e-reader, a personal digital assistant (PDA), a portable multimedia player (PMP), an MP3 player, or an MP4 player.

The computer system 320 includes a memory controller 322 configured to control data processing operations of the memory device 321 and the memory device 321, an application processor 323, an input device 324, and a display unit 325.

The application processor 323 may display data stored in the memory device 321 on the display unit 325, based on data input via the input device 324. For example, the input device 324 may be embodied as a pointing device such as a touch pad and a computer mouse, a keypad, or a keyboard. The application processor 323 may control overall operations of the computer system 320 and an operation of the memory controller 322.

In one embodiment, the memory controller 322 configured to control an operation of the memory device 321 may be embodied as a part of the application processor 323, or may be embodied as a chip installed separately from the application processor 323.

In one embodiment, the application processor 323 may be embodied as the application processor 110 of FIG. 2.

FIG. 10 is a block diagram of a computer system 330 including the application processor 110 of FIG. 2 in accordance with another embodiment of the inventive concept.

Referring to FIG. 10, the computer system 330 may be embodied as either an image process device, e.g., a digital camera, or a mobile phone, a smart phone, or a tablet PC to which a digital camera is attached.

The computer system 330 includes a memory device 331, and a memory controller 332 configured to control a data processing operation (e.g., a write or read operation) of the memory device 331. The computer system 330 may further include an application processor 333, an image sensor 334, and a display unit 335.

The image sensor 334 of the computer system 330 transforms an optical image into digital signals, and transmits the digital signals to the application processor 333 or the memory controller 332. Under control of the application processor 333, the digital signals may be displayed on the display unit 335, or stored in the memory device 331 via the memory controller 332.

Also, data stored in the memory device 331 may be displayed on the display unit 335, under control of the application processor 333 or the memory controller 332.

In one embodiment, the memory controller 332 configured to control an operation of the memory device 331 may be embodied as a part of the application processor 333, or may be embodied as a chip installed separately from the application processor 333.

In one embodiment, the application processor 333 may be embodied as the application processor 110 of FIG. 2.

The application processor 333 in accordance with the present embodiment may control a voltage to be applied to the memory device 331 according to the operating speed of the memory device 331.

The foregoing embodiments are illustrative of the inventive concept. Although certain embodiments have been described, those skilled in the art will readily appreciate that many modifications are possible in embodiments without materially departing from the novel teachings and advantages. Accordingly, all such modifications are intended to be included within the scope of this inventive concept as defined by the following claims.

What is claimed is:

1. An application processor operating in a system including a power management integrated circuit (PMIC) and a memory device operating in response to a first power supply voltage, the application processor comprising:
a nonvolatile memory device that stores control information for the memory device, wherein the control information defines in part at least the first power supply voltage and a first operating clock frequency for the memory device;
a memory control unit (MCU) that controls operation of the memory device and provides a MCU workload indication related to queued operation commands directed to the memory device; and
a dynamic voltage and frequency scaling (DVFS) controller that receives the MCU workload indication and the control information, and in response, communicates a power supply voltage command to the PMIC that defines at least in part the first power supply voltage.

2. The application processor of claim 1, wherein the control information includes are least a voltage target table (VTT) for the memory device correlating the first power supply voltage and the first operating clock frequency.

3. The application processor of claim 1, wherein the MCU and the memory device operate according to the same clock domain.

4. The application processor of claim 3, wherein the MCU operates in response to a second power supply voltage provided by the PMIC, wherein the second power supply voltage is defined at least in part by a power supply command provided by the DVFS controller to the PMIC.

5. The application processor of claim 4, wherein the MCU operates in response to the first operating clock frequency, wherein the second operating clock frequency is defined at least in part by the power supply command.

6. The application processor of claim 4, further comprising:
a central processing unit (CPU) that controls overall operation of the application processor and provides a corresponding CPU workload indication,
wherein the CPU operates in response to a third power supply voltage provided by the PMIC and defined at least in part by a power supply command provided by the DVFS controller in response to the CPU workload indication.

7. The application processor of claim 6, further comprising:
a peripheral block controlled by the CPU and providing a corresponding peripheral workload indication,
wherein the peripheral block operates in response to a fourth power supply voltage provided by the PMIC and defined at least in part by a power supply command provided by the DVFS controller in response to the peripheral workload indication.

8. The application processor of claim 2, wherein the control information includes at least one of a manufacturing company for the memory device, a product name for the device, and a process revision identification for the memory device.

9. The application processor of claim 1, wherein the memory device is a dynamic random access memory (DRAM), and the MCU is a DRAM controller.

10. An application processor operating in a system including a power management integrated circuit (PMIC) and a memory device operating in response to a first power supply voltage and storing control information that defines in part at least the first power supply voltage and a first operating clock frequency for the memory device, the application processor comprising:
a memory control unit (MCU) that controls operation of the memory device, reads the control information from the memory device, and provides a MCU workload indication related to queued operation commands directed to the memory device; and
a dynamic voltage and frequency scaling (DVFS) controller that receives the MCU workload indication and control information, and in response, communicates a power supply voltage command to the PMIC that defines at least in part the first power supply voltage.

11. The application processor of claim 10, wherein the control information includes are least a voltage target table (VTT) for the memory device correlating the first power supply voltage and the first operating clock frequency.

12. The application processor of claim 10, wherein the MCU and the memory device operate according to the same clock domain,
the MCU operates in response to a second power supply voltage provided by the PMIC, and
the second power supply voltage is defined at least in part by a power supply command provided by the DVFS controller to the PMIC.

13. The application processor of claim 12, further comprising:
a central processing unit (CPU) that controls overall operation of the application processor and provides a corresponding CPU workload indication, wherein the CPU operates in response to a third power supply voltage provided by the PMIC and defined at least in part by a power supply command provided by the DVFS controller in response to the CPU workload indication; and
a peripheral block controlled by the CPU and providing a corresponding peripheral workload indication, wherein the peripheral block operates in response to a fourth power supply voltage provided by the PMIC and defined at least in part by a power supply command provided by the DVFS controller in response to the peripheral workload indication.

14. A method of driving an application processor in a system including a power management integrated circuit (PMIC) and a memory device operating in response to a first power supply voltage, the application processor including a memory control unit (MCU) and a dynamic voltage and frequency scaling (DVFS) controller, the method comprising:
obtaining control information for the memory device, wherein the control information defines in part at least the first power supply voltage and a first operating clock frequency for the memory device;
communicating a MCU workload indication related to queued operation commands directed to the memory device to the DVFS controller;
using the DVFS controller to provide a power supply voltage command to the PMIC in response to the MCU workload indication and the control information; and
providing the first power supply voltage from the PMIC to the memory device in response to the power supply voltage command.

15. The method of claim 14, wherein obtaining the control information for the memory device comprises:
using a mode register read (MRR) operation performed by the MCU and directed to the memory device to obtain at least part of the control information.

16. The method of claim 15, wherein the application processor further includes a nonvolatile memory device storing additional control information and obtaining the control information for the memory device further comprises:
using the DVFS controller to read the additional control information from the nonvolatile memory device.

17. The method of claim 15, wherein the control information includes are least a voltage target table (VTT) for the memory device correlating the first power supply voltage and the first operating clock frequency.

18. The method of claim 14, further comprising:
providing a second power supply voltage from the PMIC to the MCU, wherein the second power supply voltage is defined at least in part by a power supply command provided by the DVFS controller to the PMIC.

19. The method of claim 18, wherein the application processor further includes a central processing unit (CPU) that controls overall operation of the application processor, and the method further comprises:
providing a CPU workload indication from the CPU to the DVFS controller; and
providing a third power supply voltage from the PMIC to the CPU, wherein the third power supply voltage is defined at least in part by a power supply command provided by the DVFS controller in response to the CPU workload indication.

20. The method of claim 19 wherein the application processor further includes a peripheral block controlled by the CPU, and the method further comprise:
providing a peripheral workload indication from the peripheral block to the DVFS controller; and
providing a fourth power supply voltage from the PMIC to the peripheral block, wherein the fourth power supply voltage is defined at least in part by a power supply command provided by the DVFS controller in response to the peripheral workload indication.
